(19) United States
(12) Patent Application Publication
(10) Pub. No.: US 2007/0146544 A1
(43) Pub. Date: Jun. 28, 2007

(54) AV apparatus for showing volume adjustment and method therefor

(76) Inventors: Bao-Kim Liu, Guei-Shan Hsiang (TW); Jung-Yi Yang, Taoyuan County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/396,745

(22) Filed: Apr. 3, 2006

(30) Foreign Application Priority Data
Dec. 27, 2005 (TW) 094146646

(51) Int. Cl. H04N 5/44

(52) U.S. Cl. 348/553; 348/725; 348/563

(57) ABSTRACT

An AV apparatus for showing a volume adjustment and a method therefor are provided. When the AV apparatus enters a screen-off mode, the AV apparatus determines whether a volume is adjustable in response to a volume adjustment signal. If yes, the volume is controlled for adjustment and a first indicatory signal is generated for visually displaying the adjustment. If not, a second indicatory signal is generated for visually displaying the inability of adjustment.

### CROSS-REFERENCES TO RELATED APPLICATIONS

This application claims priority to Taiwan Patent Application No. 094146646 filed on Dec. 27, 2005.

### BACKGROUND OF THE INVENTION

1. Field of the Invention

The present invention relates to an AV apparatus and a method for showing volume adjustment, more specifically, to an AV apparatus and a method for showing volume adjustment action via an indicatory device when a screen-off mode is entered.

2. Descriptions of the Related Art

In recent years, large-scale AV apparatuses, such as plasma TV receivers, projection TV receivers, and LCD TV receivers, have gradually become mainstream products on the market. Since these large-scale AV apparatuses consume more power than conventional AV apparatuses do, the manufacturers make their efforts on power saving. FIG. 1 is a block diagram illustrating a conventional projection TV. The projection TV comprises an antenna 10, a tuner module 11, a 20 video unit 12, an audio unit 13, a micro-controller 14, an input device 15 and an indicatory device 16, wherein the video unit 12 comprises a video processing circuit 120, an optical engine with bulb 121 and a screen 122. The audio unit 13 comprises an audio processing circuit 130, an audio amplifier 131 and at least a speaker 132. The indicatory device 16 visually displays an on/off status of the projection TV.

The antenna 10 of the projection TV receives the TV RF signal from air and transfers to the tuner module 11. The tuner module 11 is equipped to receive the TV RF signal and to output baseband audio and video signals after demodulation. The baseband video signals from various channels are displayed via the video unit 12 after being processed and transformed to a format adapted to an utilized display unit (not shown) within the optical engine with bulb 121. More specifically, after the baseband video signal conveyed in the selected channel is transferred to a formatted video image via the video processing circuit 120, the formatted video image is projected onto the screen 122 via the optical engine with bulb 121. Moreover, sound is processed via the audio unit 13. First, the baseband audio signal of the selected channel outputted by the tuner module 11 is transferred to the audio processing circuit 130. The audio signal, which has been formatted and been transformed, is amplified via the audio amplifier 131 and is outputted to the speaker 132. The micro-controller 14 is in charge of the individual operation of the circuits in the projection TV, for example, controlling the tuner module 11 to output a baseband signal conveyed in a certain channel according to the selecting signal inputted by the input device 15, or controlling the audio unit 13 to adjust the volume according to the signal for volume adjustment inputted by the input device 15.

A screen-off mode is supported by various manufacturers for saving the power consumption of the optical engine with bulb 121. That is, the video unit 12 is temporarily shut off and merely makes the audio unit 13 to be on normal operation. In other words, the projection TV only outputs audio without video for power saving. However, the default volumes in the various channels are different in real application. The volume could be turned to maximum under the condition that the audio information in some channels probably is none or is too weak when the projection TV merely outputs audio without video and the users could not get information of volume from the screen. The users may be scared or the speakers 132 may be damaged due to an unexpected large volume once the channel with audio signals is switched or the users continuously adjust it but in vain because the users did not receive related information when the volume has adjusted to a degree of maximum or minimum.

In order to solve the problems, some AV apparatuses immediately prohibit volume adjustment when the screen-off mode is entered. However, the default volumes in various channels are diverse. Thus, it is extremely inconvenient for the users if it is unable to be adjusted.

According to the above-mentioned, it is a significant problem to provide an AV apparatus and a method for indicatory volume adjustment in a screen-off mode by using the present hardware resources to save power consumption and costs.

### SUMMARY OF THE INVENTION

The primary objective of this invention is to provide an AV apparatus for displaying a volume adjustment. The AV apparatus comprises an input device, a micro-controller, and an indicatory device. The input device is utilized to input a signal for the volume adjustment. The micro-controller is utilized to determine whether a volume is adjustable in response to the signal when the AV apparatus enters into a screen-off mode. If yes, the volume adjustment is controlled to generate a first indicatory signal, and if no, a second indicatory signal is generated. The indicatory device accomplishes a first indicatory action in response to the first indicatory signal and accomplishes a second indicatory action in response to the second indicatory signal. The first indicatory action and the second indicatory action visually display a status of the volume adjustment.

Another objective of this invention is to provide a method for displaying a volume adjustment. The method comprises the steps of determining whether a screen-off mode is entered, receiving a signal for the volume adjustment, determining whether a volume is adjustable in response to the signal if the screen-off mode is determined entered, controlling the volume adjustment and generating a first indicatory signal if the volume is determined adjustable, generating a second indicatory signal if the volume is determined not adjustable, displaying a first indicatory action visually in response to the first indicatory signal and displaying a second indicatory action visually in response to the second indicatory signal.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a block diagram illustrating a conventional projection TV;

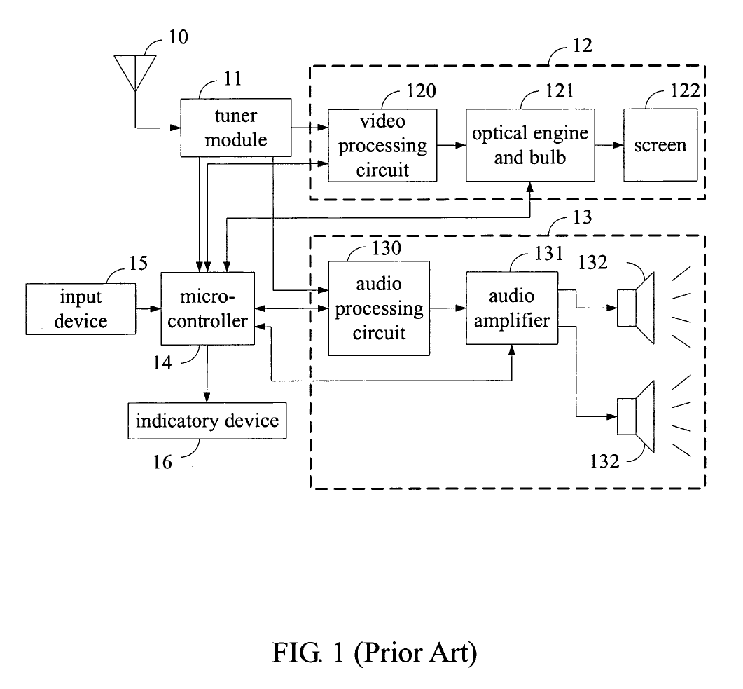

FIG. 2 is a block diagram of a preferred embodiment illustrating an AV apparatus of the present invention;

FIG. 3 is a flow chart of an embodiment of the present invention illustrating an indicatory method of volume adjustment; and

FIG. 4 is a flow chart of another embodiment of the present invention illustrating an indicatory method of volume adjustment.

### DESCRIPTION OF THE PREFERRED EMBODIMENT

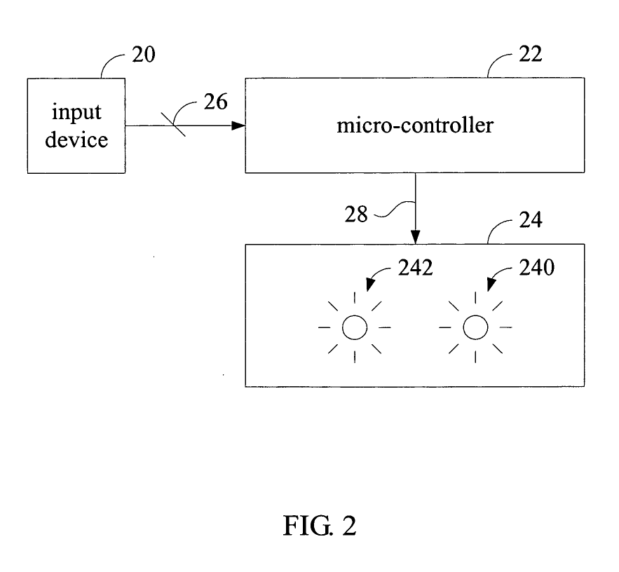

FIG. 2 illustrates a preferred embodiment of an AV apparatus of the present invention. The embodiment is a rear projection TV, comprising an input device 20, a micro-controller 22 and an indicatory device 24. The input device 20 could be a remote control or a keypad of the rear projection TV which is utilized to input a signal 26 for volume adjustment. The micro-controller 22 is utilized to determine whether a volume is adjustable in response to the signal 26 when the rear projection TV enters a screen-off mode. If yes, the volume adjustment is controlled to generate a first indicatory signal, and if no, a second indicatory signal is generated. The first indicatory signal and the second indicatory signal could be transferred to the indicatory device 24 via a wire 28. The indicatory device 24 accomplishes a first indicatory action in response to the first indicatory signal and accomplishes a second indicatory action in response to the second indicatory signal, wherein the first indicatory action and the second indicatory action visually display statuses of volume adjustment. The indicatory device 24 could be an LED (light emitting diode) or could comprise a first LED 240 and a second LED 242 as shown in the figure.

If the indicatory device 24 consists of a single LED, the first indicatory action is to flash the LED indicating that volume is being adjusted and the second indicatory action is to activate illumination without flashing the LED indicating that the volume is adjusted to a degree of maximum or minimum and it is not able to be adjusted further.

The micro-controller 22 could further determine whether the input device 20 continuously inputs the signal 26, that is, whether the user continuously requests for volume adjustment. If no, a third indicatory signal is generated and transferred to the indicatory device 24 via the wire 28. The indicatory device 24 accomplishes a third indicatory action in response to the third indicatory signal and the third indicatory action is utilized to visually display the volume adjustment is over. For example, flash the LED one time to indicate an ending of adjustment procedure. Therefore, the rear projection TV could use the single LED of the indicatory device 24 to visually display various statuses of the volume adjustment.

If the indicatory device 24 comprises the first LED 240 and the second LED 242, the first indicatory action is to flash the first LED 240 and the second indicatory action is to activate illumination without flashing the first LED 240 when the signal 26 indicates to increase the volume. The micro-controller 22 further determines whether the input device 20 continuously inputs the signal 26 to increase the volume. If no, a third indicatory signal is generated. The indicatory device 24 accomplishes a third indicatory action in response to the third indicatory signal, for example, flashing the first LED 240 one time.

The first indicatory action is to flash the second LED 242 and the second indicatory action is to activate illumination without flashing the second LED 242 when the signal 26 indicates to decrease the volume. The micro-controller 22 further determines whether the input device 20 continuously inputs the signal 26 to decrease the volume. If no, a fourth indicatory signal is generated. The indicatory device 24 accomplishes a fourth indicatory action in response to the fourth indicatory signal, for example, flashing the second LED 242 one time.

As above-mentioned, because the indicatory device 24 comprises two LEDs, the present invention arranges an LED (i.e. the first LED 240) to display a status of increasing volume and the other LED (i.e. the second LED 242) to display a status of decreasing volume. More specifically, the first LED 240 could be located above or located on a right side when a user faces the rear projection TV in accordance with the user's supposition that an upper or right side indicates to increase the volume.

Moreover, the first LED 240 and the second LED 242 of the present invention emit different colors of light for easily being distinguished by the user. For example, the first LED 240 emits red light and the second LED 242 emits yellow light.

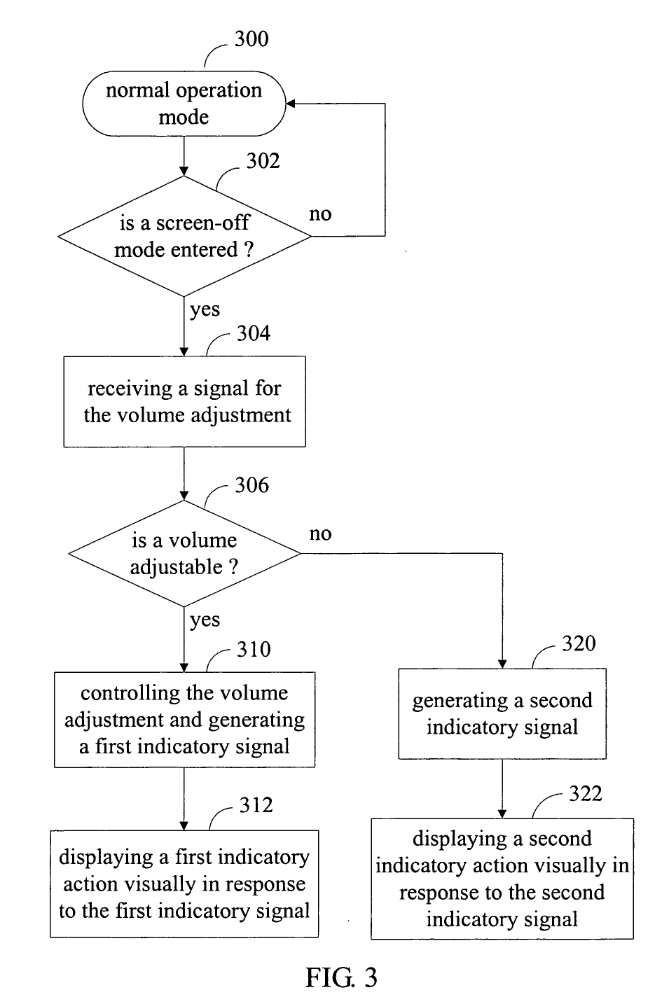

FIG. 3 is an embodiment of the present invention illustrating an indicatory method of volume adjustment. First, in step 300 a normal operation mode is performed. Step 302 is performed to determine whether a screen-off mode is entered. If no, goes back to step 300, and if yes, step 304 is performed to receive a signal of the volume adjustment. Then, step 306 is performed to determine whether a volume is adjustable in response to the signal. Step 310 is performed to control the volume adjustment and to generate a first indicatory signal if the volume is determined adjustable. Then, step 312 is performed to visually display a first indicatory action in response to the first indicatory signal. If the volume is determined not adjustable in step 306, step 320 is performed to generate a second indicatory signal. Then, step 322 is performed to visually display a second indicatory action in response to the second indicatory signal.

The embodiment, as shown in FIG. 3, further comprises a step of providing an LED, wherein the first indicatory action is to flash the LED indicating that the volume is being adjusted by the user and the second indicatory action is to activate illumination without flashing the LED indicating that the volume is adjusted to a degree of maximum or minimum and it is not able to be adjusted further.

The embodiment could be similar to the above-mentioned embodiment of the AV apparatus which comprises a step of determining whether the signal is continuously inputted. If no, a step of generating a third indicatory signal and a step of flashing the LED one time in response to the third indicatory signal for visually displaying an end of the volume adjustment are performed.

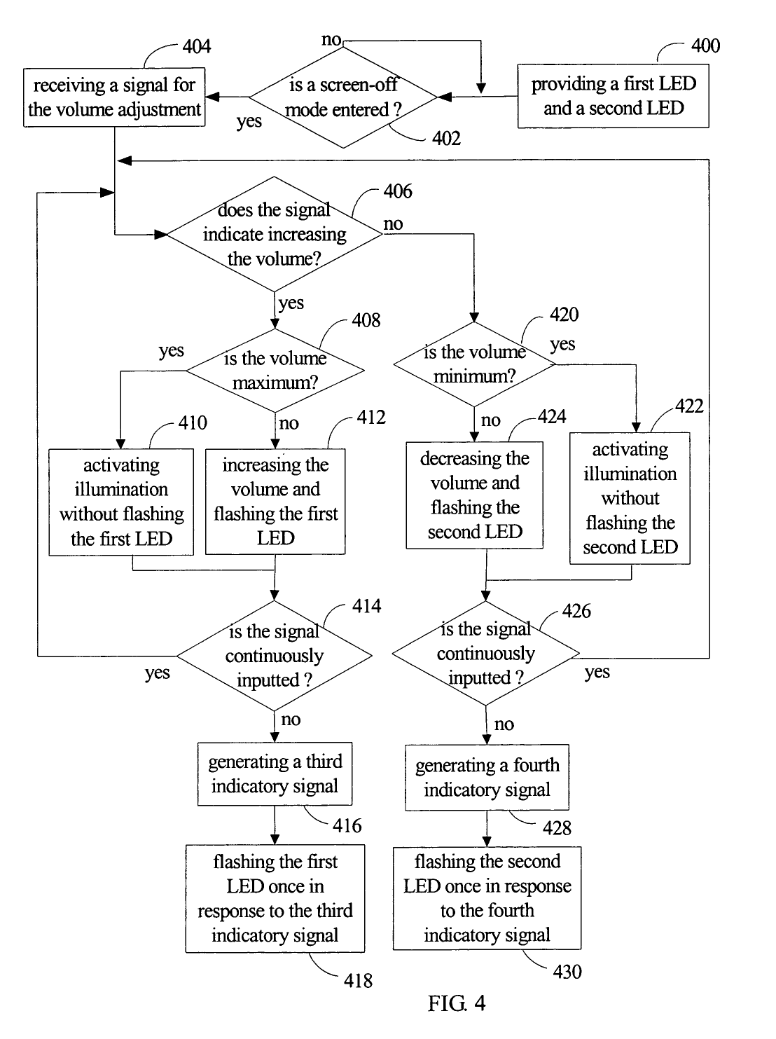

FIG. 4 is another embodiment of the present invention illustrating an indicatory method of volume adjustment. First, a first LED and a second LED are provided in step 400. In other words, two LEDs are applied in this embodiment. Next, in step 402, whether a screen-off mode is entered is determined. If no, re-performs step 402 after a period of time, and if yes, performs step 404, which is to receive a signal of volume adjustment. Then, step 406 is performed to determine whether the signal is to increase the volume. If yes, step 408 is performed to determine whether the volume is in maximum. If a positive judgment is determined in step 408, step 410 is performed subsequently to activate illumination without flashing the first LED. If a negative judgment is determined in step 408, step 412 is performed subsequently to increase the volume and to flash the first LED. In Step 414, to determine whether the signal for increasing the volume is continuously inputted is performed after the steps of 410 and 412. If yes, goes back to step 406, and if no, step 416 is performed to generate the third indicatory signal and to flash the first LED one time in response to the third indicatory signal is performed in step 418.

If a negative judgment is determined in step 406, which indicates that the signal is to decrease the volume, step 420 is performed to determine whether the volume is in minimum. If yes, step 422 is performed subsequently to activate illumination without flashing the second LED. If no, step 424 is performed to decrease the volume and to flash the second LED. After the steps of 422 and 424, step 426 is performed to determine whether the signal is continuously inputted to decrease the volume. If yes, goes back to step 406, and if no, step 428 is performed to generate a fourth indicatory signal and to flash the second LED one time in response to the fourth indicatory signal in step 430.

In the embodiment as shown in FIG. 4, when the user increases the volume, the first LED is flashed and the second LED is activated illumination without flashing. If the volume is already in maximum, the two LEDs keep illuminating without flashing. Similarly, when the user decreases the volume, the second LED is flashed and the first LED is activated illumination without flashing. If the volume is already in minimum, the two LEDs keep illuminating without flashing.

As above-mentioned, the first LED of the embodiment as shown in FIG. 4 could be an LED located above or the one located on a right side when the user faces the AV apparatus. Moreover, the first LED and the second LED are able to emit different color of light for easily distinguished by users. For example, the first LED emits red light and the second LED emits yellow light.

To sum up, the present invention discloses an AV apparatus indicating a status of adjustment in a screen-off mode for a user using conventional display resources. It could efficiently solve the prior problems which lack the relative information of volume adjustment.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An AV apparatus for displaying a volume adjustment, comprising:
an input device for inputting a signal for the volume adjustment;
a micro-controller for determining whether a volume is adjustable in response to the signal when the AV apparatus enters a screen-off mode, if yes, controlling the volume adjustment and generating a first indicatory signal, and if no, generating a second indicatory signal; and
an indicatory device for accomplishing a first indicatory action in response to the first indicatory signal and accomplishing a second indicatory action in response to the second indicatory signal;
wherein the first indicatory action and the second indicatory action visually display a status of the volume adjustment.

2. The AV apparatus as claimed in claim 1, wherein the indicatory device is an LED.

3. The AV apparatus as claimed in claim 2, wherein the first indicatory action is to flash the LED.

4. The AV apparatus as claimed in claim 2, wherein the second indicatory action is to activate illumination without flashing the LED.

5. The AV apparatus as claimed in claim 2, wherein the micro-controller determines whether the input device continuously inputs the signal, if no, generates a third indicatory signal, the indicatory device accomplishes a third indicatory action in response to the third indicatory signal, and the third indicatory action is to visually display an end of the volume adjustment.

6. The AV apparatus as claimed in claim 5, wherein the third indicatory action is to flash the LED once.

7. The AV apparatus as claimed in claim 1, wherein the indicatory device comprises a first LED and a second LED.

8. The AV apparatus as claimed in claim 7, wherein the first LED emits red light and the second LED emits yellow light.

9. The AV apparatus as claimed in claim 7, wherein the first indicatory action is to flash the first LED and the second indicatory action is to activate illumination without flashing the first LED when the signal indicates increasing the volume.

10. The AV apparatus as claimed in claim 9, wherein the micro-controller determines whether the input device continuously inputs the signal to increase the volume, if no, generates a third indicatory signal, the indicatory device accomplishes a third indicatory action in response to the third indicatory signal, and the third indicatory action is to flash the first LED once.

11. The AV apparatus as claimed in claim 9, wherein the first indicatory action is to flash the second LED and the second indicatory action is to activate illumination without flashing the second LED when the signal indicates decreasing the volume.

12. The AV apparatus as claimed in claim 11, wherein the micro-controller determines whether the input device continuously inputs the signal to decrease the volume, if no, generates a fourth indicatory signal, the indicatory device accomplishes a fourth indicatory action in response to the fourth indicatory signal, and the fourth indicatory action is to flash the second LED once.

13. The AV apparatus as claimed in claim 11, wherein the first LED is located above the second LED.

14. The AV apparatus as claimed in claim 11, wherein when a user faces the AV apparatus, the first LED is located on a right side of the second LED.

15. A method for displaying a volume adjustment, comprising the steps of:
determining whether a screen-off mode is entered;
receiving a signal for the volume adjustment;
determining whether a volume is adjustable in response to the signal if the screen-off mode is determined entered;
controlling the volume adjustment and generating a first indicatory signal if the volume is determined adjustable;
generating a second indicatory signal if the volume is determined not adjustable;
displaying a first indicatory action visually in response to the first indicatory signal; and
displaying a second indicatory action visually in response to the second indicatory signal.

16. The method as claimed in claim 15, further comprising the step of:
providing an LED;
wherein the first indicatory action is to flash the LED and the second indicatory action is to activate illumination without flashing the LED.

17. The method as claimed in claim 15, further comprising the step of:
providing a first LED and a second LED; and
determining whether the signal indicates increasing the volume;
wherein the first indicatory action is to flash the first LED and the second indicatory action is to activate illumination without flashing the first LED if the signal is determined to indicate increasing the volume.

18. The method as claimed in claim 17, further comprising the step of:
determining whether the signal is continuously inputted;
generating a third indicatory signal if the signal is determined not continuously inputted and is determined to indicate increasing the volume; and
flashing the first LED once in response to the third indicatory signal.

19. The method as claimed in claim 17, wherein the first indicatory action is to flash the second LED and the second indicatory action is to activate illumination without flashing the second LED if the signal is determined not to indicate increasing the volume.

20. The method as claimed in claim 19, further comprising the step of:
determining whether the signal is continuously inputted;
generating a fourth indicatory signal if the signal is determined not continuously inputted and is determined not to indicate increasing the volume; and
flashing the second LED once in response to the fourth indicatory signal.
